(19) United States
(12) Patent Application Publication
(10) Pub. No.: US 2010/0176721 A1
(43) Pub. Date: Jul. 15, 2010

(54) PLASMA DISPLAY PANEL

(76) Inventors: Ken Hasegawa, Osaka (JP); Keisuke Sumida, Osaka (JP); Morio Fujitani, Osaka (JP); Kenichi Kusaka, Osaka (JP); Hideyuki Shirahase, Osaka (JP); Kohshiroh Mizuno, Osaka (JP); Koji Aoto, Hyogo (JP); Keiji Horikawa, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/602,575

(22) PCT Filed: Apr. 1, 2009
(86) PCT No.: PCT/JP2009/001525

§ 371 Date: Dec. 1, 2009

(30) Foreign Application Priority Data
Apr. 4, 2008 (JP) 2008-097912
Apr. 4, 2008 (JP) 2008-097913

(51) Int. Cl. H01J 17/49

(52) U.S. Cl. 313/584

(57) ABSTRACT

A plasma display panel including rear glass substrate having address electrode, insulating layer, barrier rib and a phosphor layer thereon. Insulating layer does not contain lead. An average value of a void ratio of a region at a depth of up to 50% from rear glass substrate in a thickness of insulating layer ranges from 5% to 15%. A plasma display panel having a long lifetime and high productivity is achieved.

### TECHNICAL FIELD

The present invention relates to a plasma display panel used in a display device and the like.

### BACKGROUND ART

Recently, expectations for a large-screen wall-mount television set as a bi-directional information terminal have increased. Display devices therefor include many devices such as a liquid-crystal display panel, a field emission display, and an electroluminescence display. Among these display devices, much attention has focused on a plasma display panel (hereinafter, referred to as “PDP”) as a thin display device excellent in visibility because it is a self light-emitting type display device capable of displaying beautiful images and achieving a large screen easily, and the like. Development of PDPs with higher definition and larger screen is being carried out.

A PDP includes a front panel having a display electrode, a dielectric layer, and a protective layer made of MgO; and a rear panel having an electrode, a barrier rib, an insulating layer, a phosphor layer, and the like. The front panel and the rear panel are disposed facing each other with small discharge cells (hereinafter, referred to as “cells”) of R, G and B therebetween, and sealed together at the peripheries with a sealing material. The cell is filled with discharge gas such as mixture gas of neon (Ne) and xenon (Xe) at a pressure of, for example, 66500 Pa (about 500 Torr).

Since PDPs are originally self light-emitting type, each cell has an extremely high viewing angle. However, according to the trend toward to higher definition and larger screen, a uniform panel property is demanded in the entire area. Therefore, various measures with respect to material properties and structure formation processes have been taken. An example of disclosed methods includes a method of obtaining uniform light emission from a phosphor in the change of a viewing angle by a method of defining discharge space and a phosphor shape and subjecting the portions to coating process twice to form the structure.

Information of prior art document relating to the invention of this application includes patent documents 1 and 2.

As recent increase of the interest in environmental problems, technologies using components substantially without containing lead have been developed. For an insulating layer of a rear panel of a PDP, materials containing lead as a component have been used. Recently, however, technologies using materials substantially without containing lead instead of materials containing lead have been established.

However, it is clear that when an insulating layer without containing lead is used, a voltage necessary to discharge is gradually increased over the cumulative lighting time of a PDP, and at last, lighting cannot be carried out with a voltage set in a circuit. Since such phenomenon determines the lifetime of PDPs, it is extremely important to solve this problem in terms of extending the lifetime of PDPs.

[Patent document 1] Japanese Patent Unexamined Publication No. 2000-208057

[Patent document 2] Japanese Patent Unexamined Publication No. 2006-040794

### SUMMARY OF THE INVENTION

A PDP of the present invention includes a front glass substrate and a plurality of display electrodes disposed on the front glass substrate; and a rear panel including a rear glass substrate, address electrodes disposed on the rear glass substrate in a direction intersecting the display electrodes, and an insulating layer disposed on the address electrode. The front panel and the rear panel are disposed facing each other with discharge space therebetween. The insulating layer does not contain lead. An average value of a void ratio of a region at a depth of up to 50% from the rear glass substrate in a thickness of the insulating layer ranges from 5% to 15%.

Furthermore, a PDP of the present invention includes a front glass substrate and a plurality of display electrodes disposed on the front glass substrate; and a rear panel including a rear glass substrate, address electrodes disposed on the rear glass substrate in a direction intersecting the display electrodes, and an insulating layer disposed on the address electrode. The front panel and the rear panel are disposed facing each other with discharge space therebetween. The insulating layer does not contain lead. A surface roughness Ra of the surface of the insulating layer ranges from 0.5 μm to 0.75 μm.

Furthermore, a PDP of the present invention includes a front glass substrate and a plurality of display electrodes disposed on the front glass substrate; and a rear panel including a rear glass substrate, address electrodes disposed on the rear glass substrate in a direction intersecting the display electrodes, and an insulating layer disposed on the address electrode. The front panel and the rear panel are disposed facing each other with discharge space therebetween. The insulating layer does not contain lead. A reflectance at a wavelength of 550 nm of the surface of insulating layer ranges from 50% to 67%.

According to the present invention, even if a PDP has an insulating layer without containing lead, a PDP capable of discharging stably and having a long lifetime can be achieved.

### BRIEF DESCRIPTION OF THE DRAWINGS

FIG. 1 is a perspective sectional view showing a schematic configuration of a PDP in accordance with an exemplary embodiment of the present invention.

FIG. 2 is a perspective view showing a configuration of a rear panel of the PDP.

FIG. 3 is a graph showing a relation between a void ratio and a lighting part spread amount in the PDP.

FIG. 4 is a graph showing a relation between a void ratio and a coating margin amount in the PDP.

FIG. 5 is a graph showing a relation between Ra and a lighting part spread amount in the PDP.

FIG. 6 is a graph showing a relation between Ra and a coating margin amount in the PDP.

FIG. 7 is a graph showing a relation between a reflectance and a lighting part spread amount in the PDP.

### REFERENCE MARKS IN THE DRAWINGS

10 PDP
20 front panel
21 front glass substrate
22 scan electrode
23 sustain electrode
24 display electrode
25 black stripe
26 dielectric layer
27 protective layer
30 rear panel
31 rear glass substrate
32 address electrode
33 insulating layer
34 barrier rib
34a longitudinal barrier rib
34b lateral barrier rib
35 phosphor layer
35R red phosphor layer
35G green phosphor layer
35B blue phosphor layer
40 discharge space

### DETAILED DESCRIPTION OF THE PREFERRED EMBODIMENT

Hereinafter, a PDP in accordance with an exemplary embodiment of the present invention is described with reference to drawings.

### Exemplary Embodiment

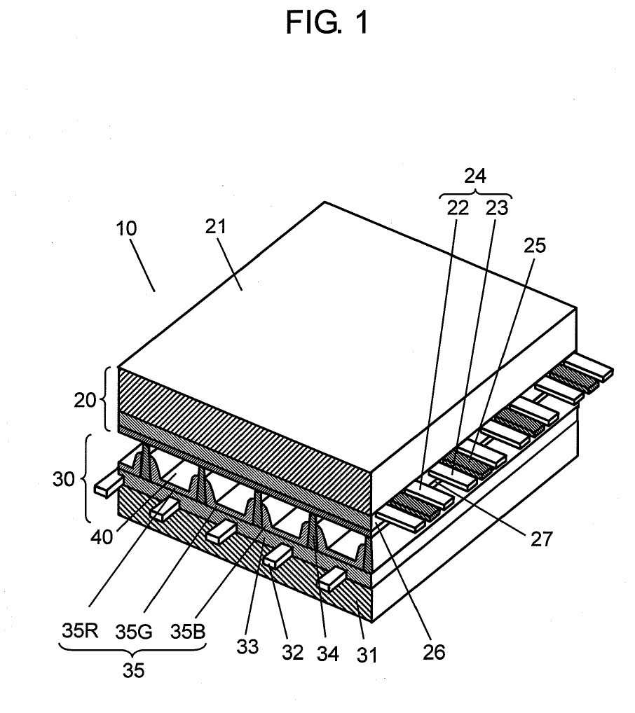

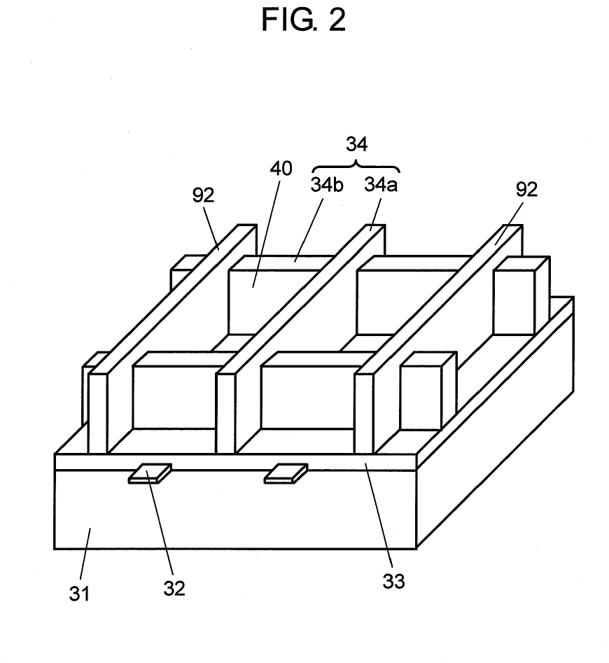

Configurations and features of a PDP in accordance with an exemplary embodiment of the present invention are described with reference to FIGS. 1 to 7. Firstly, a main configuration of the PDP of the present invention is described with reference to FIGS. 1 to 2. FIG. 1 is a perspective sectional view showing a schematic configuration of the PDP in accordance with the exemplary embodiment of the present invention. FIG. 2 is a perspective view showing a configuration of a rear panel of the PDP.

In FIG. 1, PDP 10 includes front panel 20 and rear panel 30. Front panel 20 and rear panel 30 are disposed facing each other with discharge space 40 therebetween. Front panel 20 includes front glass substrate 21 of sodium borosilicate glass produced by a float process, and a plurality of stripe-shaped display electrodes 24 each composed of a pair of scan electrode 22 and sustain electrode 23 formed on front glass substrate 21. Furthermore, black stripe 25 as a light-shielding portion is formed between adjacent display electrodes 24. Furthermore, dielectric layer 26 is formed so as to cover display electrode 24 and black stripe 25. Furthermore, protective layer 27 made of magnesium oxide (MgO) is formed so as to cover dielectric layer 26.

On the other hand, rear panel 30 includes rear glass substrate 31, and address electrodes 32 formed on rear glass substrate 31 in the direction orthogonal to display electrodes 24 on front panel 20. Insulating layer 33 is provided so as to cover address electrode 32. Furthermore, on insulating layer 33, for example, stripe-shaped or lattice-shaped barrier ribs 34 are provided. Phosphor layer 35 is formed on the side surface of barrier rib 34 and on the surface of insulating layer 33. Red phosphor layer 35R emitting red light, green phosphor layer 35G emitting green light, and blue phosphor layer 35B emitting blue light are formed sequentially in discharge space 40 partitioned by adjacent barrier ribs 34.

FIG. 2 is a perspective view showing a configuration of the rear panel of the PDP in accordance with the exemplary embodiment of the present invention. As shown in FIG. 2, barrier ribs 34 of PDP 10 are formed of lateral barrier ribs 34b provided in parallel to display electrodes 24 and longitudinal barrier ribs 34a orthogonal to lateral barrier ribs 34b. Lateral barrier ribs 34b and longitudinal barrier ribs 34a are formed as lattice-shaped barrier ribs so that the height of longitudinal barrier rib 34a is somewhat higher than the height of lateral barrier rib 34b. In addition to this shape, the present invention can include flush lattice-shaped barrier ribs, and stripe-shaped barrier ribs excluding lateral barrier ribs 34b.

Scan electrode 22 and sustain electrode 23 constituting display electrode 24 provided on front panel 20 include a transparent electrode and a bus electrode, respectively. The bus electrode is made of a material such as chromium (Cr)/copper (Cu)/chromium (Cr) or silver (Ag) and electrically connected to the transparent electrode.

The above-mentioned front panel 20 and rear panel 30 are disposed facing each other with barrier ribs 34 interposed therebetween such that display electrodes 24 and address electrode 32 are orthogonal to each other and small discharge space 40 is provided inside. Front panel 20 and rear panel 30 are sealed together with a sealing member. Thereafter, discharge space 40 is filled with discharge gas, for example, mixture gas including neon (Ne) and xenon (Xe) and the like at a pressure of about 66500 Pa (500 Torr). Thus, a PDP is completed. Then, a video signal voltage is selectively applied to display electrode 24, thereby discharging the discharge gas. Ultraviolet rays generated thereby excite phosphor layer 35 of each color, thus emitting red light, green light, and blue light, respectively, so that a color image is displayed.

Next, a method of manufacturing rear panel 30 of PDP 10 is described. Firstly, a material layer for forming address electrode 32 is formed on rear glass substrate 31 by, for example, a method for screen printing a paste containing a silver (Ag) material or a method of forming a metal film over the entire surface, then patterning thereof by a photolithography method. Then, the material layer is fired at a predetermined temperature so as to form address electrode 32.

Next, an insulating paste that does not substantially contain lead is formed on rear glass substrate 31 and address electrode 32 in a sheet and then subjected to drying process, and firing process. Thus, insulating layer 33 is formed.

Next, by coating a barrier rib formation paste containing a material of barrier rib 34 on insulating layer 33 and patterning it into a predetermined shape, a barrier rib material layer is formed. Then, the barrier rib material layer is fired to form barrier ribs 34. Herein, a method of patterning the barrier rib formation paste coated on insulating layer 33 may include a photolithography method and a sand-blast method. Next, a phosphor paste including a phosphor material is coated between adjacent barrier ribs 34 on base dielectric layer 33 and on the side surfaces of barrier ribs 34, and fired. Thus, phosphor layer 35 is formed. In the above-mentioned process, rear panel 30 including predetermined component members on rear glass substrate 31 is completed.

In this way, front panel 20 and rear panel 30, which include predetermined component members, are disposed facing each other such that scan electrodes 22 and address electrodes 32 are disposed orthogonal to each other, and sealed together at the peripheries thereof with a glass frit. Discharge gas including, for example, neon (Ne) and xenon (Xe), is filled in discharge space 40. Thus, PDP 10 is completed.

Hereinafter, a producing method of insulating layer 33 of the present invention is described in detail.

On rear glass substrate 31 on which address electrode 32 is formed, an insulating paste is coated so as to cover address electrode 32 by, for example, a die coating method, thus forming an insulating paste layer. Then, rear glass substrate 31 is dried in, for example, a drying furnace so as to remove a solvent component in the insulating paste layer by volatilization. Next, by firing the insulating paste layer, binder in the insulating paste layer is removed and a glass component is melted. Thus, insulating layer 33 is formed.

As the insulating paste in accordance with this exemplary embodiment of the present invention, several kinds of pastes each containing 30-40% glass component, 20-30% filler, 10-20% binder, and 20-30% solvent in the blending ratio are used. At this time, the glass component is a material component that does not substantially contain lead. Furthermore, by changing the ratio between the filler and the glass component, the void ratio, surface roughness, reflectance, and the like, of insulating layer 33 can be changed. In the below-mentioned experimental results, samples are formed by changing the blending ratio and compared.

As mentioned above, in conventional technologies, over the cumulative lighting time of a PDP, a voltage necessary for discharging is gradually increased, and at last, lighting cannot be carried out with a voltage set in a circuit.

The present inventors have found a solution to the above-mentioned problem by setting an average value of the void ratio of a region at a depth of 0-50% from the side of rear glass substrate 31 in a thickness of insulating layer 33 at 5-15%.

Herein, the void ratio is a rate of a volume of a part in which insulating layer 33 is not present in insulating layer 33 and is measured by the following method.

(1) Rear panel 30 is cut and a sample in which a section of insulating layer 33 is exposed is cut out.

(2) A region at a depth of up to 50% from rear glass substrate 31 in the thickness of insulating layer 33 is photographed by using a secondary electron scanning electron microscope (SEM).

(3) The void ratio is calculated from the photographed image of the section of insulating layer 33.

Furthermore, it is desirable that the section of insulating layer 33 is coated with resin in the void portion and peripheries in order to increase the contrast at the time of SEM photographing, and to prevent measurement variation caused due to the degree of breakage in cutting. The measurement is carried out by using scanning electron microscope S-3000 (Hitachi Ltd.). The imaging used for calculation is carried out in a reflection electron measurement mode, at an acceleration voltage of 15 kV and at a work distance of 15 mm.

Furthermore, in the exemplary embodiment of the present invention, the increased degree of a voltage value necessary for lighting of PDP 10 is estimated as a lighting part spread amount. Herein, the lighting part spread amount is measured as follows.

(1) Only a certain area in a PDP image display area is lighted in white at all times and other areas are non-lighted at all times. This state is allowed to maintain for 100 hours.

(2) A phenomenon is observed in which light-emission occurs in a periphery of the area that is lighted in white at all times, i.e., an area that is originally non-lighted at all times.

(3) A width of the above-mentioned light-emitting area in the area that is non-lighted at all times is measured. This is defined as a lighting part spread amount.

This shows a state in which a lighting voltage value is changed due to the change over time in lighting of PDP 10 and is used as an index for predicting the lifetime of PDP 10 by voltage increase.

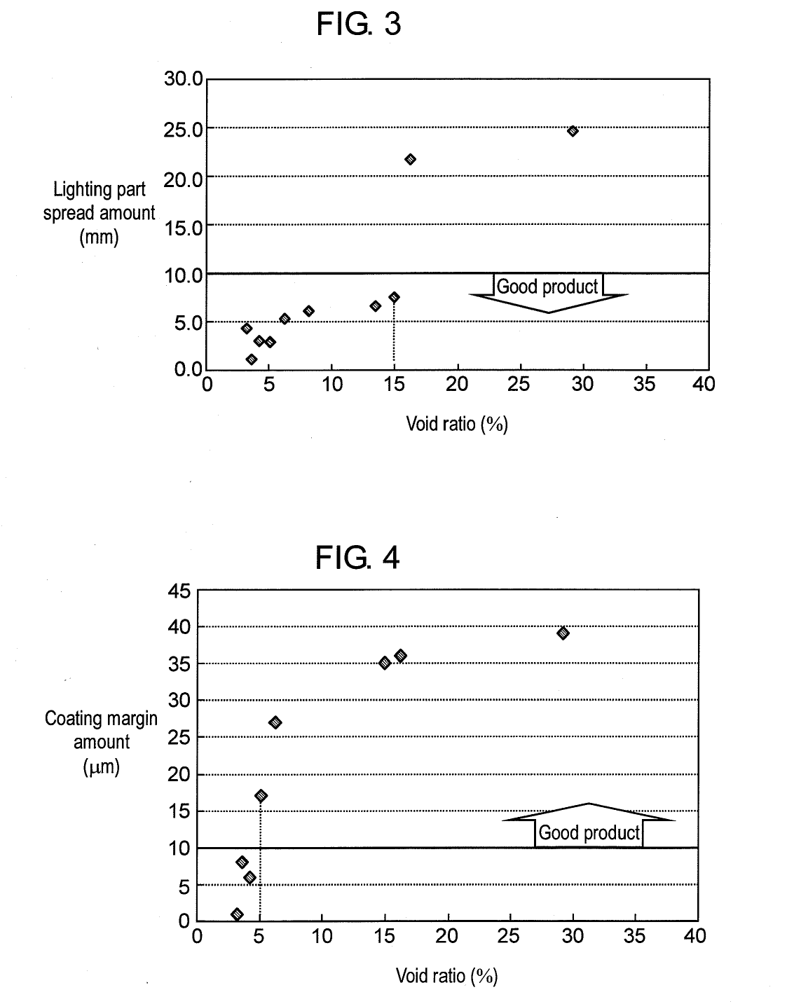

FIG. 3 is a graph showing a relation between the void ratio of insulating layer 33 and the lighting part spread amount. This shows that when an average value of the void ratio of a region at a depth of up to 50% from the side of rear glass substrate 31 in a thickness of insulating layer 33 in rear panel 30 is more than 15%, the lighting part spread amount is increased.

This is thought to be because water confined in the voids generated in insulating layer 33 in the manufacturing process is gradually released to discharge space 40 by discharging, and therefore, a discharge starting voltage is reduced.

In the exemplary embodiment of the present invention, when the lighting part spread amount is not more than 10 mm, a sufficient lifetime of PDP 10 can be achieved. That it so say, in order to secure the lifetime of PDP 10, the void ratio of insulating layer 33 needs to be not more than 15%.

Meanwhile, when the void ratio of insulating layer 33 is reduced, it is clear that other problems occur. That is to say, the present inventors have found that the decrease in the void ratio deteriorates a coating margin amount of a phosphor paste when phosphor layer 35 is formed.

Herein, the coating margin amount is a range of a proper value of the coating thickness in which the phosphor paste can be normally coated when the phosphor paste is coated on rear panel 30. For example, when the coating thickness is less than the proper value, phosphor layer 35 drops off in the portion. As a result, a discharge cell that does not emit light or a discharge cell whose brightness is low is generated, and thus the coating becomes defective.

On the other hand, when the coating thickness is larger than the proper value, the phosphor paste overflows beyond barrier rib 34 to the adjacent discharge cells. As a result, colors are mixed between discharge cells or the thickness of phosphor varies. Similarly, the coating becomes defective.

In other words, if the coating margin amount is too low, the yield of PDP is reduced due to defective coating of the phosphor. That is to say, rear panel 30 having a wide range of proper values is desired in order not to generate defective coating in the phosphor.

FIG. 4 is a graph showing a relation between the void ratio in insulating layer 33 and the coating margin amount of phosphor. In this way, this shows that as the reduction in the void ratio of a region at a depth of up to 50% from the side of rear glass substrate 31 in the thickness of insulating layer 33, the coating margin amount is also reduced. In the exemplary embodiment of the present invention, when the coating margin amount is not less than 10 μm, the incidence of defective coating of the phosphor can be permitted. That is to say, in order to secure the manufacturing yield of PDP 10, it is shown that the void ratio of a region at a depth of up to 50% from the side of rear glass substrate 31 in the thickness of insulating layer 33 needs to be not less than 5%.

As mentioned above, insulating layer 33 is required to have an average value of the void ratio of the region at a depth of up to 50% from the side of rear glass substrate 31 in the thickness of insulating layer 33 in rear panel 30 of 5-15% in order to secure the lifetime of PDP 10 and to prevent the yield from being reduced due to defective coating of phosphor.

Furthermore, the present inventors have found that the surface roughness (Ra) of insulating layer 33 in rear panel 30 has a large effect on the above-mentioned problem of conventional technologies.

Specifically, the present inventors have found that the above-mentioned problem can be solved when the surface roughness (Ra) of insulating layer 33 is made to be in the range from 0.5 μm to 0.75 μm.

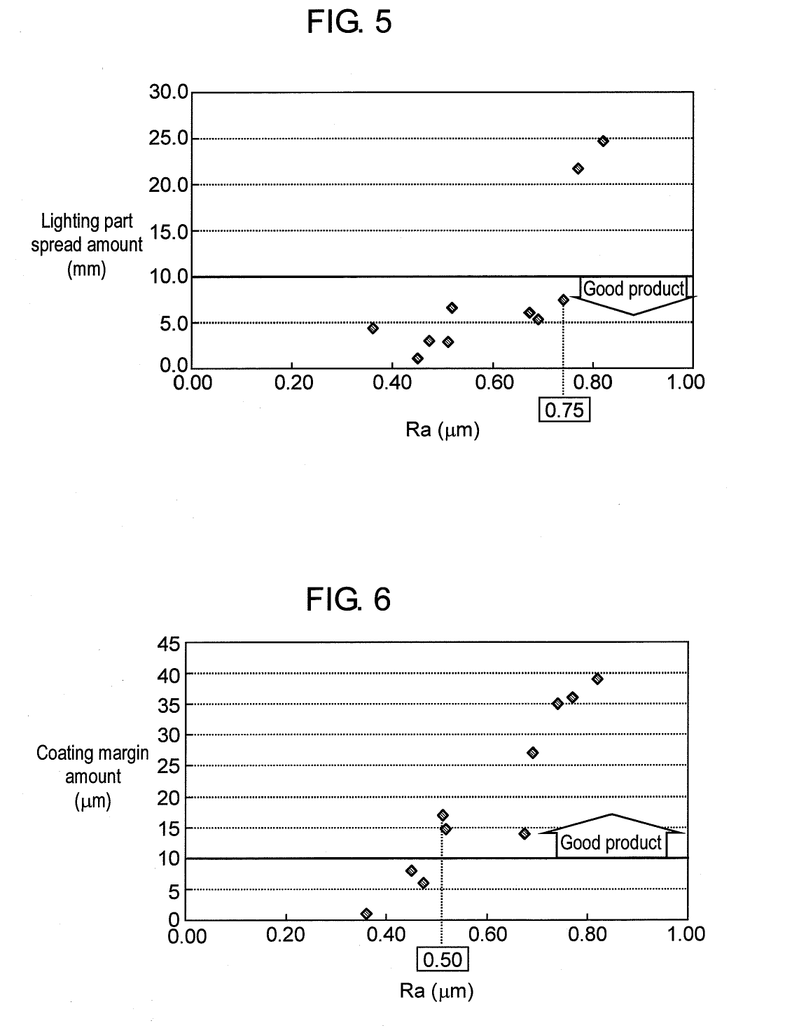

In the exemplary embodiment of the present invention, the surface roughness (Ra) is measured as a center line average roughness according to JIS-2001. Furthermore, the surface roughness is measured by using an instrument Handysurf E-35A (Tokyo Seimitsu Co., Ltd.; cutoff value=0.8 mm, and evaluation length=4 mm). Similar to the void ratio, the relation between the surface roughness and the lighting part spread amount as well as between the surface roughness and the phosphor coating margin amount are examined. The results are shown in FIGS. 5 and 6, respectively.

As shown in FIG. 5, as the surface roughness of insulating layer 33 in rear panel 30 is increased, the lighting part spread amount is increased. It is shown that in order to make the lighting part spread amount not more than 10 mm, the surface roughness (Ra) of insulating layer 33 is not more than 0.75 μm.

Meanwhile, as shown in FIG. 6, as the surface roughness (Ra) of insulating layer 33 in rear panel 30 is increased, the phosphor coating margin amount can be secured. It is shown that in order to make the phosphor coating margin amount not less than 10 μm, the surface roughness (Ra) of insulating layer 33 needs to be not less than 0.5 μm. This is because a paste state coating solution is repelled if the surface is too smooth when phosphor is coated.

As mentioned above, insulating layer 33 is required to have a surface roughness (Ra) of insulating layer 33 in rear panel 30 ranging from 0.5 μm to 0.75 μm in order to secure the lifetime of PDP 10 and to prevent the yield from reducing due to defective coating of the phosphor.

Furthermore, the present inventors have found that a reflectance of insulating layer 33 in rear panel 30 has a large effect on the above-mentioned problem of conventional technologies.

Specifically, the present inventors have found that the above-mentioned problem can be solved when the reflectance of insulating layer 33 is set to be in the range from 50% to 67%.

Herein, the reflectance is measured as the total reflectance at wavelength of 550 nm according to JIS-R-3106. Furthermore, the reflectance is measured by using Spectrophotometer: CM-3600d (MINOLTA).

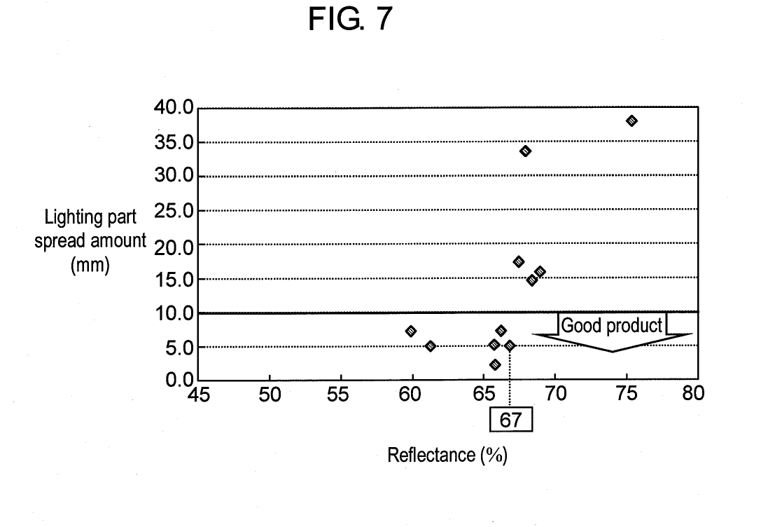

FIG. 7 is a graph showing a relation between the reflectance of insulating layer 33 and the lighting part spread amount. Thus, it is shown that when the reflectance of insulating layer 33 in rear panel 30 is more than 67%, the lighting part spread amount is increased. In the exemplary embodiment of the present invention, when the lighting part spread amount is not more than 10 mm, sufficient lifetime of PDP 10 can be achieved. In other words, in order to secure the lifetime of PDP 10, the reflectance of insulating layer 33 needs to be not more than 67%.

Meanwhile, when the reflectance of insulating layer 33 is reduced, it is clear that other problems occur. That is to say, when the reflectance is reduced, since the effect of absorption of phosphor emission in insulating layer 33 is increased, the light-emitting brightness of PDP 10 is reduced, thus deteriorating the quality of PDP 10. When the reflectance is less than 50%, the effect of the reduction in brightness is increased.

As mentioned above, it is shown that insulating layer 33 is required to have the reflectance of insulating layer 33 in rear panel 30 ranging from 50% to 67% in order to secure the lifetime of PDP 10 and in order not to reduce the quality due to the reduction in brightness.

### INDUSTRIAL APPLICABILITY

A PDP of the present invention is useful because a PDP made of a material without containing a lead component and having a long lifetime and high productivity can be provided.

1. A plasma display panel comprising:
a front panel including a front glass substrate and a plurality of display electrodes disposed on the front glass substrate; and
a rear panel including a rear glass substrate, address electrodes disposed on the rear glass substrate in a direction intersecting the display electrodes, and an insulating layer disposed on the address electrode,
the front panel and the rear panel being disposed facing each other with discharge space therebetween,
wherein an average value of a void ratio of a region at a depth of up to 50% from the rear glass substrate in a thickness of the insulating layer ranges from 5% to 15%.

2. The plasma display panel of claim 1,
wherein a surface roughness Ra of the insulating layer ranges from 0.5 μm to 0.75 μm.

3. A plasma display panel comprising:
a front panel including a front glass substrate and a plurality of display electrodes disposed on the front glass substrate; and
a rear panel including a rear glass substrate, address electrodes disposed on the rear glass substrate in a direction intersecting the display electrodes, and an insulating layer disposed on the address electrode,
the front panel and the rear panel being disposed facing each other with discharge space therebetween,
wherein a surface roughness Ra of a surface of the insulating layer ranges from 0.5 μm to 0.75 μm.

4. A plasma display panel comprising:
a front panel including a front glass substrate and a plurality of display electrodes disposed on the front glass substrate; and
a rear panel including a rear glass substrate, address electrodes disposed on the rear glass substrate in a direction intersecting the display electrodes, and an insulating layer disposed on the address electrode,
the front panel and the rear panel being disposed facing each other with discharge space therebetween,
wherein a reflectance with respect to a wavelength of 550 nm of the surface of the insulating layer ranges from 50% to 67%.

5. The plasma display panel of claim 1,
wherein the insulating layer does not contain lead.

6. The plasma display panel of claim 2,
wherein the insulating layer does not contain lead.

7. The plasma display panel of claim 3,
wherein the insulating layer does not contain lead.

8. The plasma display panel of claim 4,
wherein the insulating layer does not contain lead.
